(19) United States
(12) Patent Application Publication
(10) Pub. No.: US 2014/0016483 A1
(43) Pub. Date: Jan. 16, 2014

(54) Wireless multi-channel electronic signal measurement and generation device.

(71) Applicant: Umang Raman Patel, Mansfield, TX (US)

(72) Inventor: Umang Raman Patel, Mansfield, TX (US)

(73) Assignee: Umang Raman Patel, Mansfield, TX (US)

(21) Appl. No.: 13/545,991

(22) Filed: Jul. 11, 2012

(51) Int. Cl. H04L 12/26

(52) U.S. Cl. 370/252

(57) ABSTRACT

A wireless electronic signal measurement and generation device is presented. The device enables a host computing system, such as a smart-phone or PDA having standard wireless networking capability, to wirelessly connect to a multitude of wired electronic systems for test and measurement, such as an electronic thermometer or motor. The electronic systems under test are connected to the device by wire or probe. The device wirelessly connects to a host computing system by standard wireless network protocol, such as Bluetooth or IEEE802.11 Wi-Fi. The device supports direct unfiltered relay of measured analog data, detected digital data, and generated analog or digital signals between the host computer and connected electronic systems under test bi-directionally. The device can be embodied as a single module including a housing, wire connection ports, and a wireless connectivity module.

### BACKGROUND OF THE INVENTION

1. Field of the Invention

This invention pertains to the field of system test and measurement by electronic means. The use of this device enables a host mobile or static computing to have a DMM, digital multi-meter, or a process variable data logging or display system capabilities. Furthermore, the device enables a host computing system to have analog and digital signal generation capabilities.

2. Description of Related Art

It is common in domestic and industrial settings to measure voltage and current that are either literal electrical values or process variable representations. Furthermore, the sequential or simultaneous need to provide electronic signals to an electrical system while performing measurements is very common for both analog and digital systems.

Existing wireless digital multi-meter (DMM) and data logging systems are often used to measure process variables and typically require both transmitter and receiver devices that use proprietary wireless communication protocols. Many existing systems include device level data processing and logging capabilities that increase cost. Industry specific wireless measurement devices, such as those implemented in process control equipment, are encumbered by industry specific fixed software and hardware details that lead to the inability of customization or usage in other applications. Many systems become industry specific due to the physical connectors and embodiment of the device, which also limits versatility. Hardware connector issues can be often overcome by using interface adapters in many cases.

Well equipped full featured wireless data logging systems are normally capable of high sampling rates with high resolution which drives total system cost. Multi-channel digital oscilloscopes are a good example of a high performance data logging device that may operate from 20 Mhz to 90 Ghz or greater sampling rate range. Unlike oscilloscopes, digital multi-meters(DMM) have low sampling rates due to their measured values are displayed in numerical recognizable time interval of less than 20 Hz; therefore, expensive high sample rate systems are not needed in situations where digital multi-meters and low speed data loggers are applicable, especially in mechanical processes involving temperature, motion, and fluids. Often the case arises for the simultaneous need of signal measurement and signal generation to debug, assess performance, or control an electrical integrated system. The versatility to adapt a signal measurement and generation device for a wide range of applications to meet the aforementioned need brings high value to the user, even though some industry specific details are not included in the traditional manner. Furthermore, enabling the user with a highly configurable interface to said device including but not limited to features such as data plotting, data logging, data display, signal generation control, and measurement feedback signal control loops using existing hardware, such as a smart-phone, would be exemplary.

### BRIEF SUMMARY OF THE INVENTION

The device allows for collecting multiple channels of data wirelessly using a smart-phone or other computing device via commercially standard wireless network protocols. Measured data is directly sent to the host from the device without any processing or memory buffering.

The device can also, but not limited to simultaneously, produce electrical signals, such as pulse width modulation or serial data, as commanded by the wirelessly connected host computing system. Wired connection is required between the device and systems under test. Interface connector adapters can be directly wired to the device as needed. The device requires a power supply either dedicated or shared from a system under test. Device sample rate capability is limited by the commercial wireless protocol data rate. Although the sample rate would not be comparable to an oscilloscope, but can exceed common digital multi-meter display rates.

The inventor realizes that a wireless interface to enable a host computing system such as a smart-phone, to be used as a digital multi-meter, data-logger, sensor read-out, motion controller, and bi-directional digital hardware interface is highly advantageous due to host computer versatility and host computer electrical decoupling from the systems under test. Furthermore, the device directly sends measured data to the host computing system without device local computations requiring all data processing to take place in the host computing system. A multi-channel analog switch with a analog to digital converter is used in the invention to acquire signal measurements from a multitude of devices under test.

### BRIEF DESCRIPTION OF THE SEVERAL VIEWS OF THE DRAWING

FIG. 1. illustrates an embodiment of the invention.

FIG. 2. illustrates an exploded view of an embodiment of the invention.

FIG. 3. illustrates a simplified schematic diagram of an embodiment of the invention in an operational condition.

FIG. 4. illustrates a simplified block diagram of the internal circuitry of an embodiment of the invention.

### DETAILED DESCRIPTION OF THE INVENTION

A wireless multi-channel electronic signal measurement and generation device is presented. The device includes electrical connectors, a housing, a microprocessor, a multi-channel analog switch, an analog to digital converter, a circuit board, and a wireless module. The device includes a standard wireless connectivity module such as Bluetooth or IEEE802.11 Wi-Fi compliant wireless connectivity module to wirelessly connect to a mobile computing device, such as a smart-phone. The device also includes a multitude of means to electrically connect wired connections to external electronic systems that would be under test. The device requires a power supply that can be embodied in several ways, such as a battery pack wired to the device or integrated batteries directly installed within the device.

The device can separately or simultaneously measure electrical voltages, measure electrical currents, supply digital signals and analog voltage waveforms in multiplicity under the control from a host computing system. The analog to digital converter is preceded by a multi-channel analog switch to sample multiple channels in a serial manner. Digital data input and output can be directly communicated through the device where the digital data deciphering and encoding would occur at the host computing device. Digital encoding schemes and protocols such as Manchester encoding, CAN bus, I2C, and others can be controlled and interpreted by the host computing device with algorithms and software programming.

Host computing systems may connect to this device to produce a synchronized electronic test, data logging, and control system. The device can receive commands from the host computing device and respond by reporting the requested data. The host computing system's processing capability, memory, display, and extended network connectivity can be used to process, store, display, and pass data from and to the device.

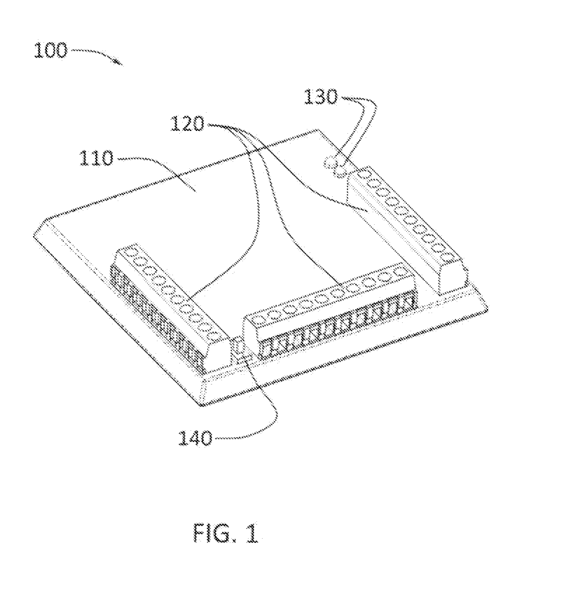

FIG. 1. illustrates an embodiment of the invention as an electronic device 100 that includes a top cover 110, connectors 120, indicator lights 130, and switch 140. The disclosed embodiments can take many alternate forms such as size, shape, color, various connectors, and integrated accessories that could be adopted therein. Such accessories could be battery holders, clamps, indicator lights, infra-red emitters(IrDA), infra-red light sensors, light sensors, visual display, knobs, and dials used therein for various purposes. Such accessory items can be ‘add-on’ components to the device 100 or integrated into the device 100. In one embodiment as shown in FIG. 1., there are three sets of connectors 120 as each 10 position terminal block connector arrays. This embodiment allows for many device 100 connections to electrical systems under test by wired electrical connection. These connections to device 100 can be, but not limited to, are several grounds, +5 volt supply output, +3.3 volt supply output, three 5 volt measure range inputs, two 20 volt measure range inputs, two 40 volt measure range inputs, a 0.1 amp measure range through-put, a 1.0 amp measure range through-put, a 10.0 amp measure range through-put, three digital outputs, and one digital input.

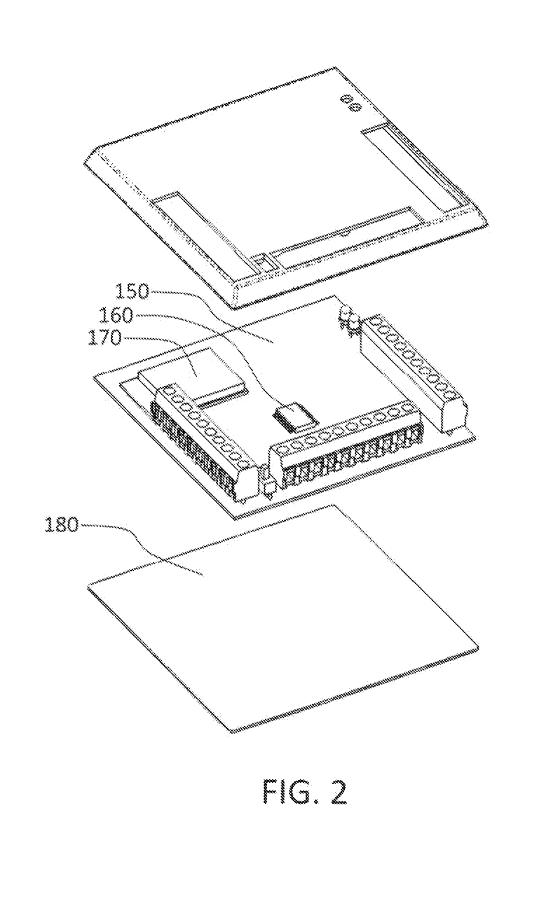

FIG. 2. illustrates an exploded view of an embodiment of the invention that is illustrated in FIG. 1. as an electronic device 100. FIG. 2. illustrates the embodiment of the invention to include a printed circuit board 150, microprocessor chip 160, wireless connectivity module 170, and base cover 180. The electronic device 100 includes circuitry for measuring voltages, measuring current, receive digital input, and deliver digital output signals to and from a multitude of devices connected via wire to the device 100. Various mechanical fasteners, chemical adhesives, and soldering methods can be employed in several fashions to assemble the device 100 from electrical components such as the microprocessor 160, and mechanical hardware such as the top cover 110 and base cover 180.

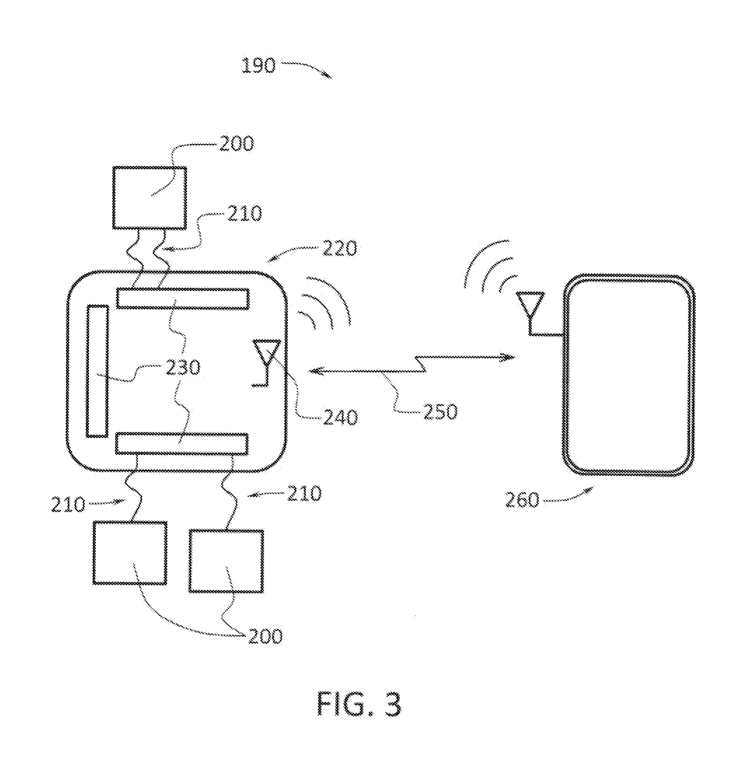

FIG. 3. illustrates a simplified schematic diagram of an embodiment of the invention in an operational condition 190 that wirelessly communicates 250 measured voltages, measured currents, digital inputs and digital outputs directly to and from a host computing device 260. FIG. 3. illustrates device 100 as a simplified schematic block referred herein as device block representation 220. The device block representation 220 is wired 210 to systems 200 under test by connectors 230. Systems 200 that can be operationally used with the device 220 could be, but not limited to, sensors, servos, motors, automotive digital communications bus such as CAN, and other circuits. In the embodiment shown, the wireless connection from device block representation 220 is made using a wireless connectivity module with a built-in antenna 240 that communicates to a host computing device 260 using a standard wireless network protocol. Host computing device 260 can be any computing device or wireless connection relay that is capable of the same standardized wireless connectivity found in a particular model device 100. Host computing device 260 can be, but not limited to, a personal data assistant device, a multimedia player device, a smart-phone, a laptop computer, or a desktop computer.

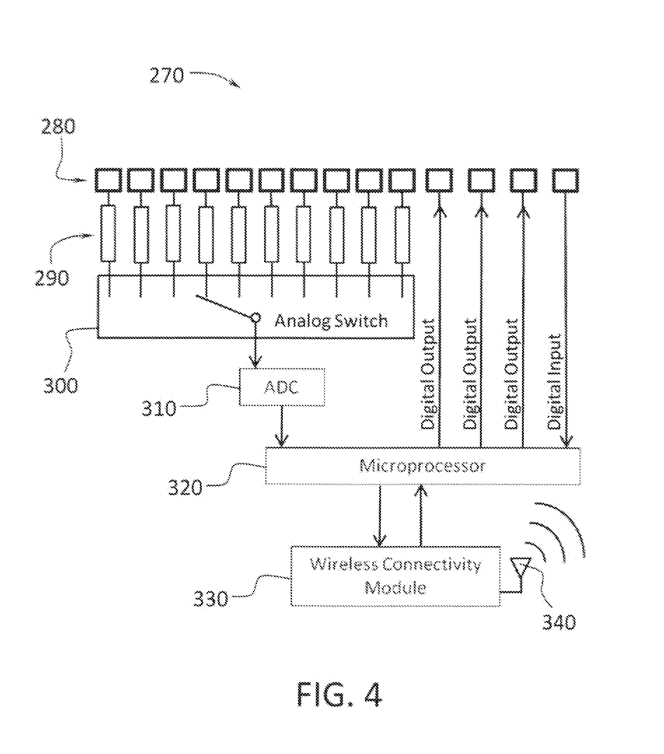

FIG. 4. illustrates a simplified block diagram 270 of an internal circuitry embodiment of the invention that would be included in device 100 of FIG. 1. and device block representation 260 of FIG. 3. Connection ports 280 represent connection locations within connectors 230 that allow the device 100 to connect to systems 200 under test or control. Interface circuits 290 convert measurement inputs and current measurement inputs into a voltage range required by the ADC 310, analog to digital converter. The analog switch 300 is controlled by the microprocessor 320 to select a particular channel for connection to the ADC 310 for analog to digital conversion feed to the microprocessor 320. For example, five channels are selected by the user at the host computing device software interface, the microprocessor 320 commands the analog switch 300 in a manner of switching channels sequentially to measure each of the five selected channels individually. The microprocessor 320 can be directly connected to the digital input and output channels. Wireless connectivity module 330 is connected to the microprocessor 320 enabling wireless connection to a host computing device 260 for bi-directional communication and data transfer. Antenna 340 is connected to the wireless connectivity module 330 allowing the required standard protocol RF radiation to occur. The antenna 340 could be a built-in antenna on the wireless connectivity module 330 circuit board or an external connected antenna. Additional circuitry such as, but not limited to, may consist of over-voltage protection circuits for each channel and power supply regulation circuits.

The device 100 requires power supply which is not shown in the Figures. The invention embodiment shown in FIG. 1. as device 100 is illustrated without batteries, but could receive power through wired connection at two ports of connector 120 for ground and positive power supply where power can be provided by an external power source or wired battery pack. An invention embodiment similar to device 100 could include integrated batteries wherein a battery cover allows access to battery replacement.

What is claimed is:

1. A wireless electronic signal measurement and generation device comprising an electronic module adapted to:
electronically couple by wires or probes to a multitude of devices under test;
wirelessly connect to a host computing system through standardized wireless network IEEE802.11 Wi-Fi or Bluetooth;
perform signal measurements comprised of digital data, analog voltage and analog current from electrically coupled devices under test;
perform multiple signal measurements from a circuit comprising a multi-channel analog switch and an analog to digital converter; and
send analog to digital converter results without modification to a host computing system.

2. The device of claim 1 adapted to sending digital and analog signals electrically coupled devices under test.

3. The device of claim 1 capable of time synchronization of signal measurement and signal generation.

4. The device of claim 1 adapted for a plurality of electronic signal measurement channels.

5. The device of claim 2 adapted for a plurality of electronic signal generation channels.

6. The device of claim 1 embodied as a module including a housing, a circuit board, a microprocessor, and a wireless connectivity module.

7. The device of claims 1, 2, and 6, wherein a wireless module, comprising:
a microprocessor with standardized wireless network software and radio frequency electronics,
a radio frequency antenna, and
an EMI, electro-magnetic-interference, protection cover.

8. The device of claim 6 including terminal block wire connectors providing means to electronically couple by wires to a multitude of devices under test;

9. The device of claim 1 further comprising an overvoltage protection circuit containing diodes connected to the ADC positive voltage supply for each of the channels.

10. A method of causing a host mobile or static computing system to function as an electronic test, control, and data logging system, comprising:
a communication protocol for bi-directional data transfer between device of claim 1 and host computing system across standardized wireless network interface of IEEE802.11 Wi-Fi or Bluetooth;
computer and network programming on host system for sending, receiving, storing, displaying, and synchronizing data to and from device; and
device microprocessor programming.

11. The method of claim 10 wherein the host computing system includes a personal computing laptop, personal computing desktop, smart-phone, handheld multi-media device, or PDA.

12. The method of claim 10 wherein the device of claim 1 is commanded by the host computing system to perform measurement and signal generation.

13. The method of claim 10 wherein the device of claim 1 is programmed by the host computing system to perform measurement and signal generation automatically.
